(19) United States
(12) Patent Application Publication
(10) Pub. No.: US 2019/0161211 A1
(43) Pub. Date: May 30, 2019

(54) AIRCRAFT WITH A SYSTEM FOR REARWARD MOUNTING AND DISMOUNTING AN ENGINE AND METHOD FOR REARWARD DISMOUNTING AN ENGINE

(71) Applicant: Airbus Operations, S.L., Getafe (ES)

(72) Inventors: Alberto ARANA HIDALGO, Getafe (ES); José Luis MARTÍNEZ MUÑOZ, Getafe (ES)

(21) Appl. No.: 16/197,719

(22) Filed: Nov. 21, 2018

(30) Foreign Application Priority Data
Nov. 24, 2017 (EP) 17382795.7

(51) Int. Cl. B64F 5/50; B64D 27/02; B64D 27/26; B64D 41/00

(52) U.S. Cl. CPC B64F 5/50; B64D 27/02; B64D 2041/002; B64D 41/00; B64D 2027/262; B64D 27/26

(57) ABSTRACT

An aircraft with a system for rearward mounting and dismounting an engine, the engine being placed inside the rear part of the aircraft when mounted. The system for rearward mounting and dismounting the engine comprises a first removable attachment device arranged to attach the engine to the fuselage in the rear part of the aircraft, internal supports fixed in the rear part of the aircraft, at least two longitudinal detachable rails, to be placed on the internal supports and under the engine, and a slider to attach to the engine via a second removable attachment device, to be placed on the longitudinal detachable rails.

### CROSS-REFERENCES TO RELATED APPLICATIONS

This application claims the benefit of the European patent application No. 17382795.7 filed on Nov. 24, 2017, the entire disclosures of which are incorporated herein by way of reference.

### FIELD OF THE INVENTION

This invention refers to an aircraft with a system for mounting and dismounting an engine from the airframe in a rearward direction. The invention also refers to a method for rearward dismounting an engine from an aircraft.

### BACKGROUND OF THE INVENTION

Currently the engines of an aircraft are usually taken to their final location in the rear fuselage of the airframe by means of a vertical lifting/lowering of the engine to match the mount fixtures where the engine is fixed.

This vertical lifting/lowering (vertical insertion or extraction) is done by means of elevators or assisted by electrical hoist kits attached to auxiliary lugs or fittings within the airframe. This vertical operation requires an open structure at the bottom of the fuselage (a maintenance door) large enough to allow the engine to lift without change in attitude (i.e., without a change in the angle of the engine with respect to the ground).

This open space thus reduces the structural capability of the fuselage and requires a maintenance door.

Some prior art documents disclose the installation of heavy equipment (such as an aircraft Auxiliary Power Unit (APU) or an engine) from the rear side of the aircraft.

U.S. Pat. No. 8,262,050 B2, refers to a “method and apparatus for mounting and dismounting an aircraft engine,” and discloses a method that includes mounting a frame assembly in supported connection with a support member of an associated aircraft. The frame assembly includes a frame member, a movable assembly mounted in movable relationship to the frame member, and a plurality of engine winches mounted in supported connection with the movable member. Each engine winch has an associated engine cable operably connected thereto. The movable assembly is movable between forward and rearward positions. The method further includes supporting the weight of at least a portion of an aircraft engine with the engine cables and moving the movable member relative to the frame member to displace the portion of the aircraft engine.

EP 3181458 A1 refers to a suspension system for an aircraft auxiliary power unit located in a fuselage structure, the system comprising a plurality of auxiliary power unit attachment brackets arranged to be attached to the auxiliary power unit, a plurality of fuselage attachment brackets attached to the auxiliary power unit attachment brackets and coupled to the fuselage structure, and additionally comprising two longitudinal elements arranged to be attached to the fuselage structure in the longitudinal direction of the aircraft for supporting the auxiliary power unit, the two longitudinal elements and the plurality of fuselage attachment brackets being connected such that the two longitudinal elements support the plurality of fuselage attachment brackets, being the fuselage attachment brackets slidably movable along the longitudinal elements for introducing or extracting the auxiliary power unit into the fuselage structure.

### SUMMARY OF THE INVENTION

Accordingly, an object of the present invention is to provide an aircraft with a system for rearward mounting and dismounting an engine in which the operations of insertion and extraction of the engine are simplified without needing a bottom maintenance door on the fuselage.

The invention provides an aircraft with a system for rearward mounting and dismounting an engine, the engine being placed inside the rear part of the aircraft when mounted, and the system for rearward mounting and dismounting the engine comprising:
a first removable attachment arrangement, such as a fastener with an elongated shaft extending parallel to a longitudinal axis of the aircraft, arranged to attach the engine to the fuselage in the rear part of the aircraft,
internal supports fixed in the rear part of the aircraft,
at least two longitudinal detachable rails, to be placed on the internal supports and under the engine, and
sliding means or a slider for attachment to the engine by means of a second removable attachment arrangement, such as a fastener with an elongated shaft extending parallel to the longitudinal axis of the aircraft, to be placed on the longitudinal detachable rails.

The system for rearward mounting and dismounting the engine makes the operations of insertion and extraction of the engine easier, regardless of whether the engine is placed horizontally or at an angle with respect to the ground, and avoids making additional openings in the fuselage.

According to another aspect, the invention provides a method for rearward dismounting an engine from the above-described aircraft that comprises the following steps:
removing the tailcone or a fairing from the rear part of the aircraft,
entering the longitudinal detachable rails into the rear part of the aircraft, and placing the longitudinal detachable rails on the internal supports and under the engine,
entering the slider into the rear part of the aircraft, placing the slider on the longitudinal detachable rails, and attaching the slider to the engine by means of the second removable attachment arrangement,
disengaging the engine from the rear part of the aircraft by detaching the first attachment arrangement,
rearward sliding of the slider and the engine on the longitudinal detachable rails,
transferring the engine onto an external fork-lift or trolley, and
disengaging the engine from the slider by detaching the second removable attachment arrangement.

According to another aspect, the invention provides a method for rearward dismounting an engine from the above-described aircraft that comprises the following steps:
removing the tailcone or a fairing from the rear part of the aircraft,
entering the longitudinal detachable rails into the rear part of the aircraft, and placing the longitudinal detachable rails on the internal supports and under the engine,
entering the slider into the rear part of the aircraft, placing the slider on the longitudinal detachable rails, and attaching the slider to the engine by means of the second removable attachment arrangement,
disengaging the engine from the rear part of the aircraft by detaching the first attachment arrangement,
rearward sliding of the slider and the engine on the longitudinal detachable rails, controlled by the pulley,
transferring the engine onto an external fork-lift or trolley,
detaching the pulley from the attachment points at the front of the engine, and
disengaging the engine from the slider by detaching the second removable attachment arrangement.

Other characteristics and advantages of the present invention will be clear from the following detailed description of several embodiments illustrative of its object in relation to the attached figures.

### BRIEF DESCRIPTION OF THE DRAWINGS

FIG. 1 is a perspective view of an aircraft with its fuselage.

FIG. 2 is a view of the rear part of the aircraft of FIG. 1, including its tailcone.

FIG. 3A and 3B are side views of the rear part of an aircraft of the prior art with an engine mounted on it (FIG. 3A), which can be dismounted vertically (FIG. 3B).

FIGS. 4A and 4B correspond to two views of a cross section of the rear part of the aircraft, with the engine and several elements of the system for rearward mounting and dismounting an engine.

FIGS. 5 to 10 show a side view of the rear part of the aircraft, with the engine and the system for rearward mounting and dismounting an engine during the steps of the process of rearward dismounting of the engine.

FIGS. 11 to 18 show a side view of the rear part of the aircraft, with the engine placed at an angle with respect to the ground and the system for rearward mounting and dismounting an engine during the steps of the process of rearward dismounting of the engine.

### DETAILED DESCRIPTION OF THE PREFERRED EMBODIMENTS

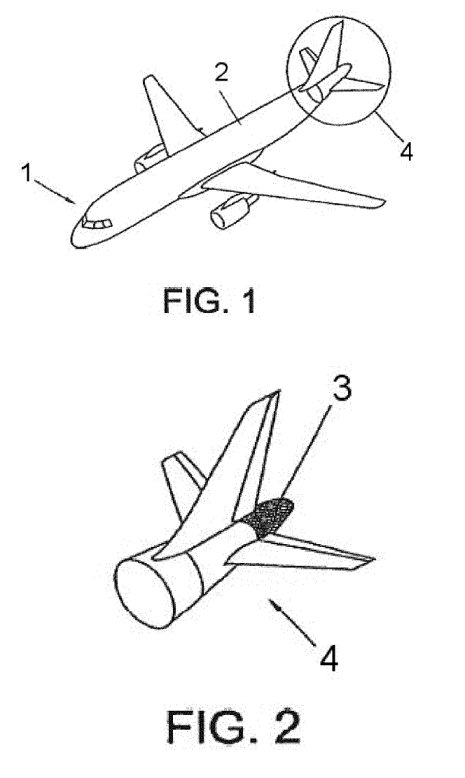

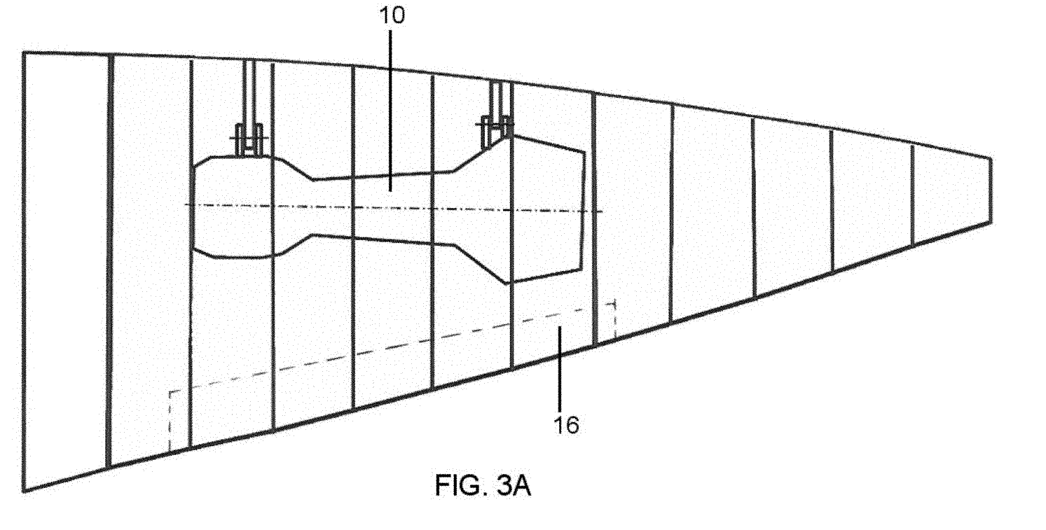

FIG. 1 shows an aircraft 1 of the invention with its aircraft fuselage 2, and FIG. 2 shows, more in detail, the rear part 4 of the aircraft 1 of FIG. 1, including the tailcone 3.

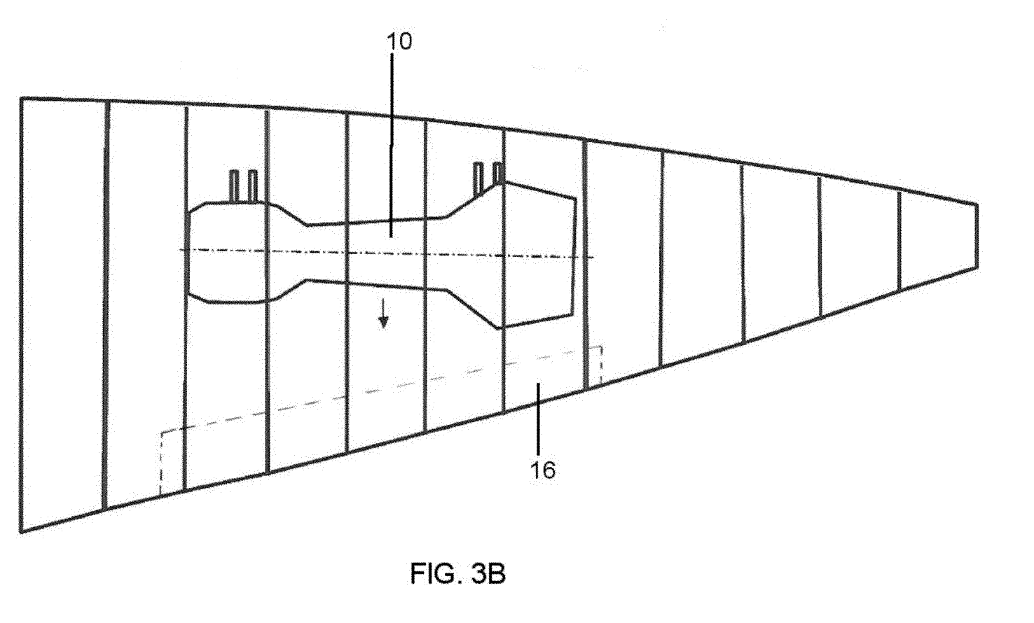

FIG. 3A is a side view of the rear part of an aircraft of the prior art with an engine 10 mounted on it, which can be dismounted vertically (as shown in FIG. 3B). As shown in these figures, the fuselage 2 has a bottom maintenance door 16 needed for the vertical lifting/lowering of the engine 10.

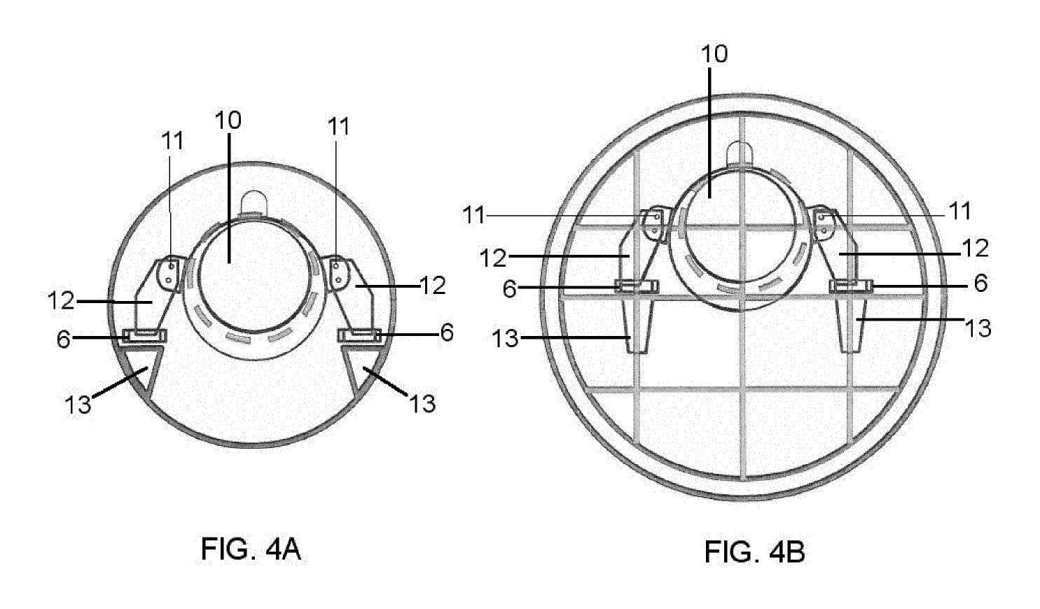

FIG. 4A is a cross section of the rear part 4 of the aircraft 1, showing the engine 10 placed horizontally inside the aircraft fuselage 2. This figure also shows some elements of the system for rearward mounting and dismounting the engine 10, such as internal supports 13 fixed in the rear part 4 of the aircraft 1, two longitudinal detachable rails 6, to be placed on the internal supports 13 and under the engine 10, and a slider 12 for attachment to the engine by means of a second removable attachment arrangement 11, such as a fastener with an elongated shaft extending parallel to a longitudinal axis of the aircraft 1 and engine 10, to be placed on the longitudinal detachable rails 6.

FIG. 4B is a cross section of the rear part 4 of the aircraft 1, when the engine 10 is placed inside the aircraft fuselage 2 at an angle with respect to the ground (i.e., not horizontally).

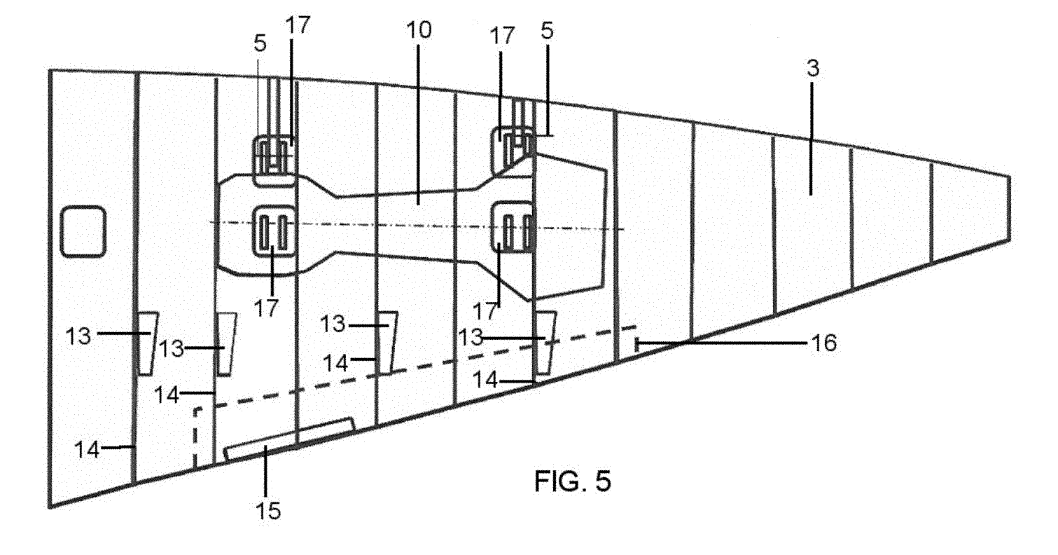

FIGS. 5 to 10 show a side view of the rear part 4 of the aircraft 1, with the engine 10 and the system for rearward mounting and dismounting an engine during the steps of the process of rearward dismounting of the engine.

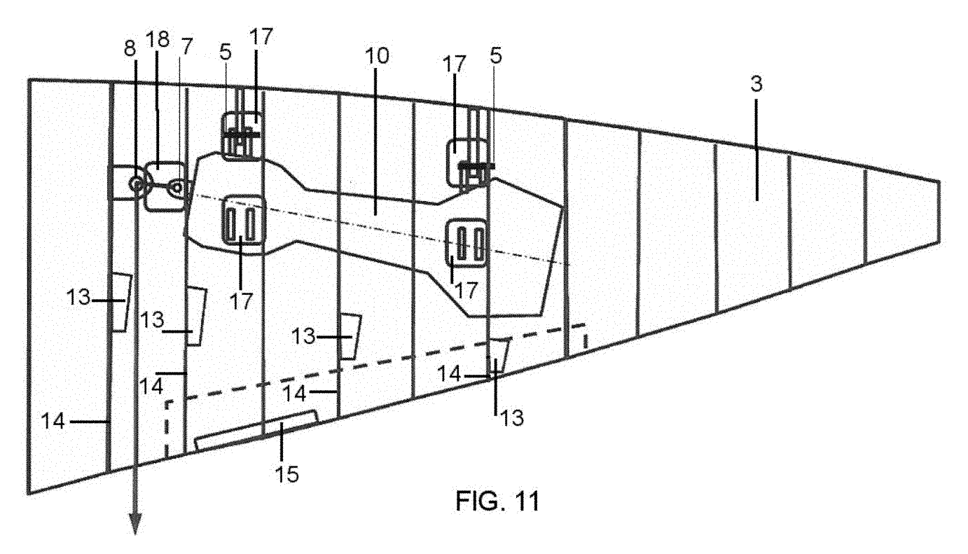

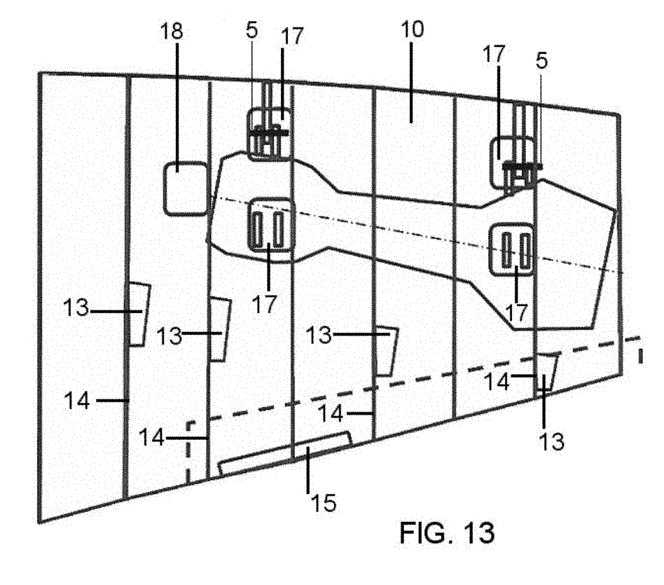

In FIGS. 5 to 10 the engine 10 is placed horizontally (i.e., horizontal to the ground when the aircraft 1 is on the ground). However, it is possible that the engine 10 is placed at an angle with respect to the ground when the aircraft 1 is on the ground (FIGS. 11 to 18).

The longitudinal detachable rails 6 are not integral part of the structure of the aircraft 1, and do not perform a function of stabilization or strengthening of the fuselage structure. They serve to support the engine 10 when it slides on them after the removable attachment arrangement 5 is detached. The first removable attachment arrangement may be a fastener with an elongated shaft extending parallel to the longitudinal axis of the aircraft 1 and engine 10.

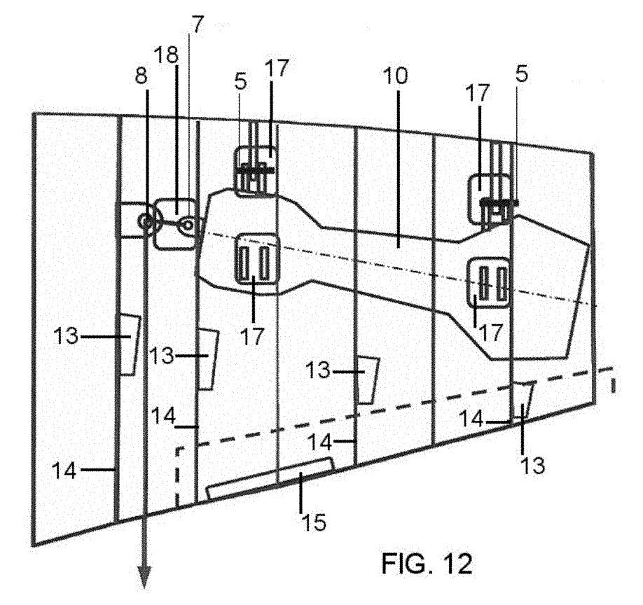

FIGS. 11 to 12 show a pulley 8 attached to the fuselage 2 of the aircraft 1 and to the attachment points 7 on the front of the engine 10 to allow the sliding of the engine 10 on the detachable rails 6 in a controlled manner This pulley 8 is another element of the system for rearward mounting and dismounting the engine 10.

The pulley 8 may be an electrical pulley, and it can be of the same type as those currently used to raise/lower the engines. The motor of the electrical pulley can be placed outside the aircraft 1.

In FIGS. 5 to 18, the fuselage 2 comprises windows 17 for accessing the first removable attachment arrangement 5 and the second removable attachment arrangement 11. In these figures it can also be seen that the service door 15 at the bottom of the fuselage is considerably smaller than the maintenance door 16 of the prior art aircraft (represented in dashed line).

The fuselage 2 also comprises a window 18 for accessing the attachment points 7 at the front of the engine 10 when the engine 10 is mounted. Accordingly, this window 18 makes it possible for the operator to attach the pulley 8 to the attachment points 7 on the front of the engine 10.

The detachable rails 6, the slider 12 and the second removable attachment arrangement 11 are not placed in the rear part 4 of the aircraft 1 when the engine 10 is mounted, which allows a reduction of weight during the flight.

The supports 13 may be fixed to the bulkheads 14 inside the rear part 4 of the aircraft 1.

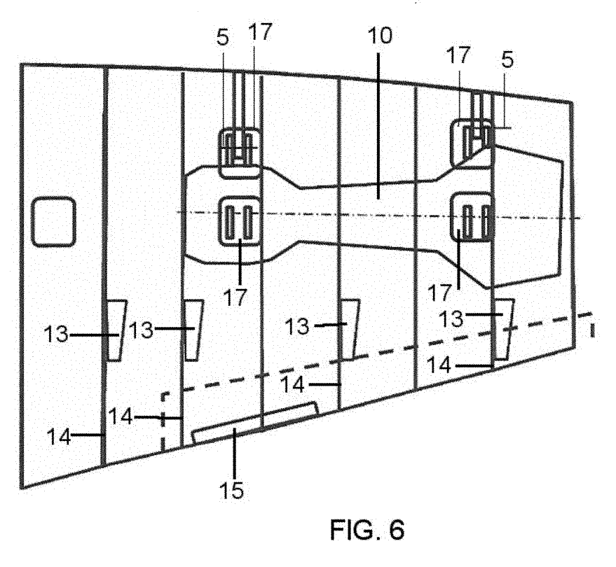

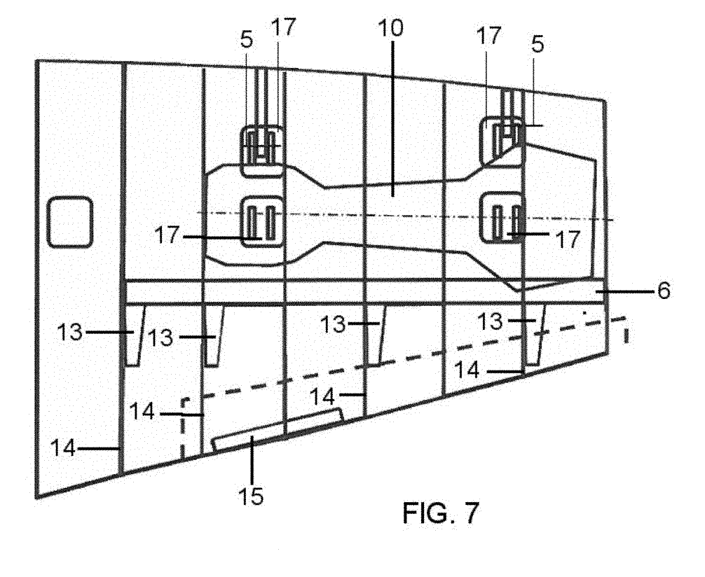

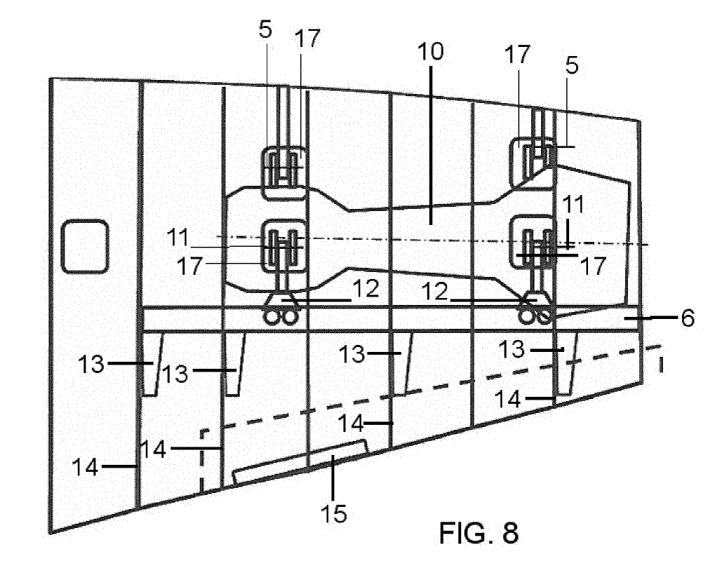

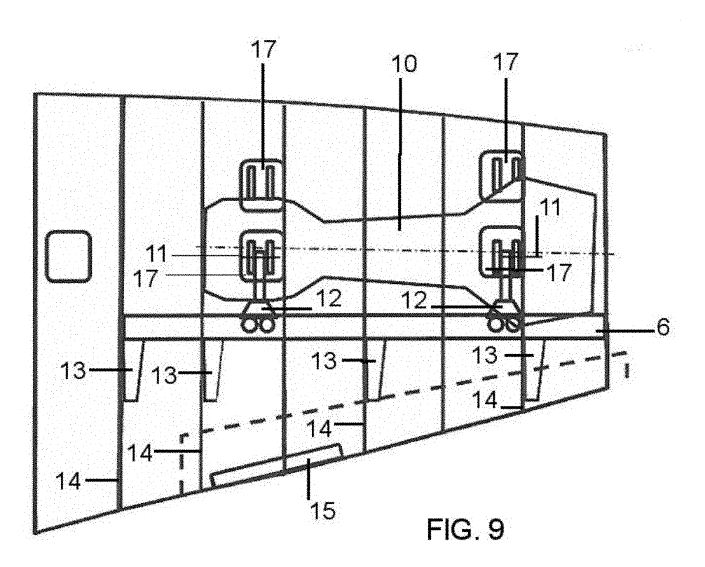

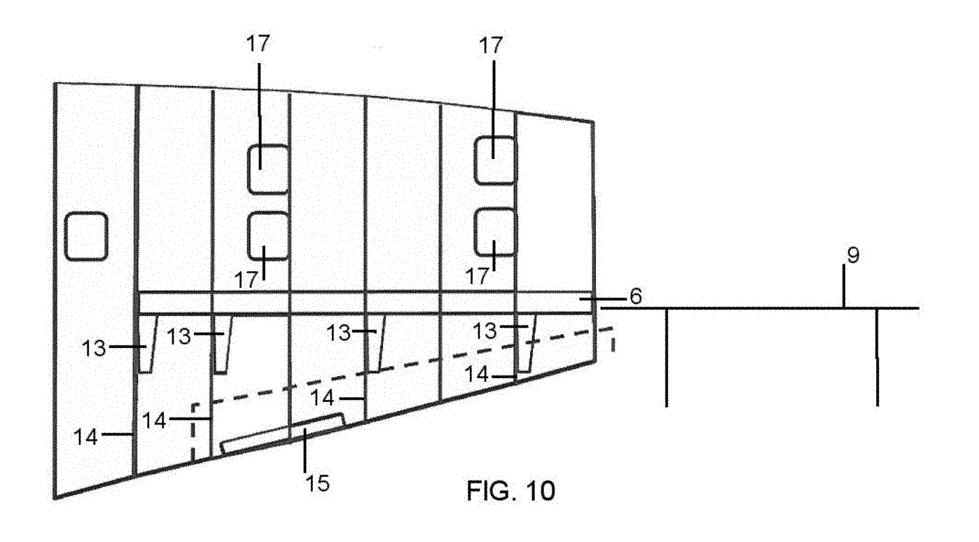

In another aspect, a method for rearward dismounting an engine 10 placed horizontally from an aircraft 1 of the invention as previously described comprises the following steps:
removing the tailcone 3 or a fairing from the rear part 4 of the aircraft 1 (FIG. 6),
entering the longitudinal detachable rails 6 into the rear part 4 of the aircraft 1, and placing the longitudinal detachable rails 6 on the internal supports 13 and under the engine 10 (FIG. 7),
entering the slider 12 into the rear part 4 of the aircraft 1, placing the slider 12 on the longitudinal detachable rails 6, and attaching the slider 12 to the engine 10 by means of second removable attachment arrangement 11 (FIG. 8),
disengaging the engine 10 from the rear part 4 of the aircraft 1 by detaching the first attachment arrangement 5 (FIG. 9),
rearward sliding of the slider 12 and the engine 10 on the longitudinal detachable rails 6 (FIG. 10),
transferring the engine 10 onto an external fork-lift or trolley 9, and
disengaging the engine 10 from the slider 12 by detaching the second removable attachment arrangement 11.

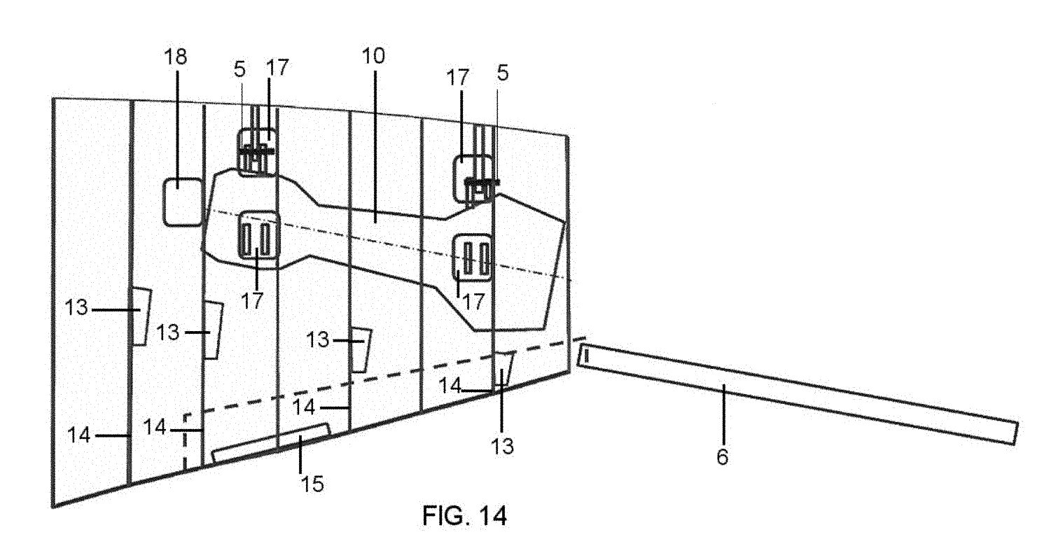

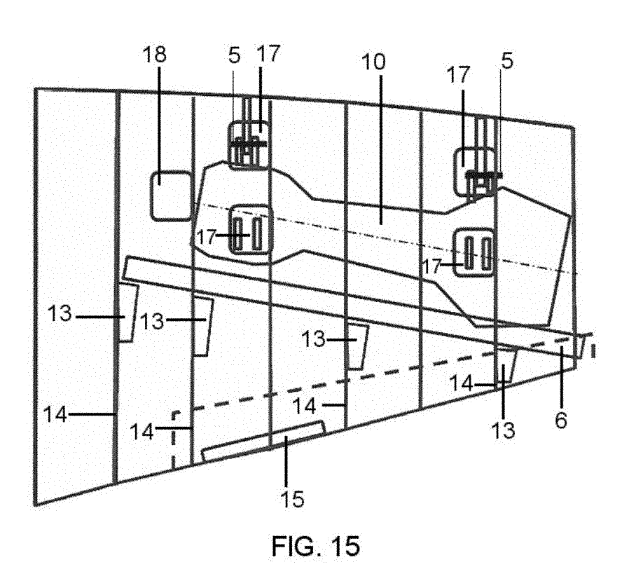

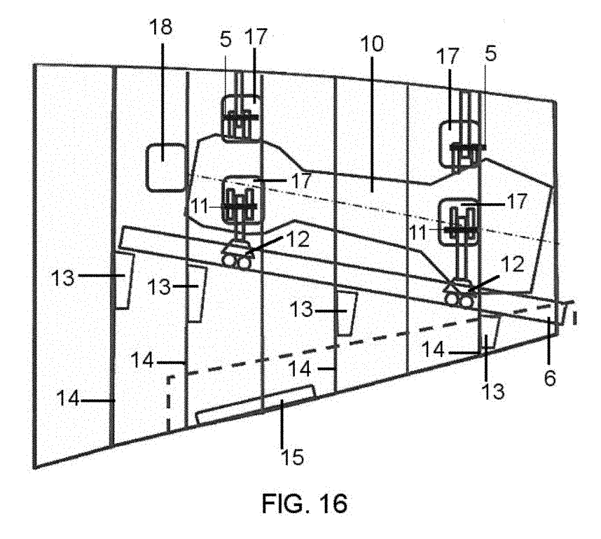

A method for rearward dismounting an engine 10 placed at an angle with respect to the ground from an aircraft 1 of the invention as previously described comprises the following steps:
removing the tailcone 3 or a fairing from the rear part 4 of the aircraft 1 (FIG. 12),
entering the longitudinal detachable rails (6) into the rear part (4) of the aircraft (1), and placing the longitudinal detachable rails (6) on the internal supports (13) and under the engine (10) (FIGS. 14 and 15),
entering the slider (12) into the rear part (4) of the aircraft (1), placing the slider (12) on the longitudinal detachable rails (6), and attaching the slider (12) to the engine (10) by means of the second removable attachment arrangement (11) (FIG. 16),

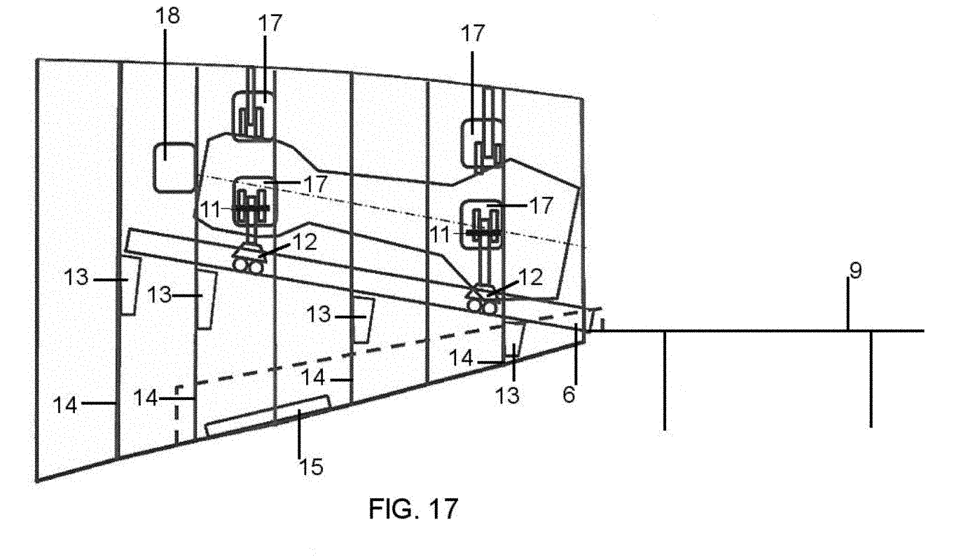

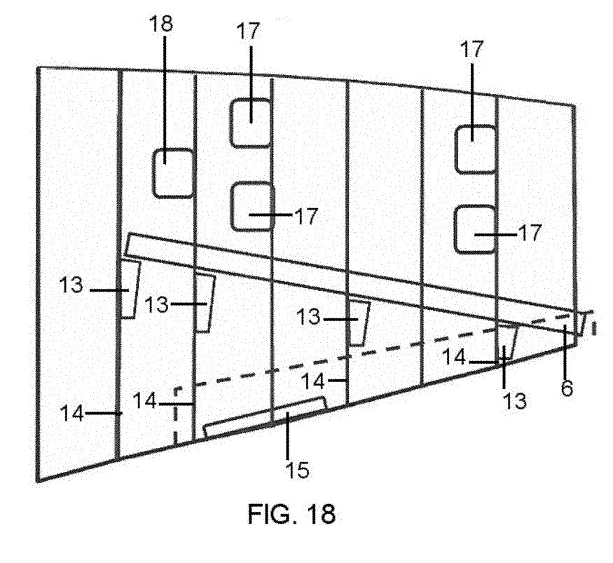

1 disengaging the engine (10) from the rear part (4) of the aircraft (1) by detaching the first attachment arrangement (5) (FIG. 17),
rearward sliding of the slider (12) and the engine (10) on the longitudinal detachable rails (6), controlled by the pulley (8) (FIG. 18),
transferring the engine (10) onto an external fork-lift or trolley (9),
detaching the pulley (8) from the attachment points (7) at the front of the engine (10), and
disengaging the engine (10) from the slider (12) by detaching the second removable attachment arrangement (11).

The pulley 8 allows the controlled displacement of the engine 10 over the longitudinal detachable rails 6 until the engine 10 is placed on a typical maintenance fork-lift or trolley 9.

When the engine 10 is placed at an angle with respect to the ground, the pulley 8 restrains the movement of the engine 10 in a longitudinal direction before the attachment arrangement 5 is detached and afterwards it allows the rearward sliding of the engine 10 in a controlled manner

Although the present invention has been fully described in connection with preferred embodiments, it is evident that modifications may be introduced within the scope thereof, not considering this as limited by these embodiments, but by the contents of the following claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising a fuselage with a system for rearward mounting and dismounting an engine, the engine being placed inside a rear part of the aircraft when mounted, the system for rearward mounting and dismounting the engine comprising a first removable attachment arrangement configured to attach the engine to the fuselage in the rear part of the aircraft, wherein the system for rearward mounting and dismounting the engine additionally comprises:
internal supports fixed in the rear part of the aircraft,
at least two longitudinal detachable rails, to be placed on the internal supports and under the engine, and
slider to attach to the engine by means of a second removable attachment arrangement, to be placed on the longitudinal detachable rails.

2. The aircraft with a system for rearward mounting and dismounting an engine according to claim 1, wherein the fuselage comprises windows for accessing the first removable attachment arrangement and the second removable attachment arrangement.

3. The aircraft with a system for rearward mounting and dismounting an engine according to claim 1, wherein the internal supports are fixed to bulkheads inside the rear part of the aircraft.

4. The aircraft with a system for rearward mounting and dismounting an engine according to claim 1, wherein the engine is placed horizontally when the aircraft is on the ground.

5. The aircraft with a system for rearward mounting and dismounting an engine according to claim 1, wherein the engine is placed at an angle with respect to the ground when the aircraft is on the ground, and comprises attachment points at the front of the engine, the system for rearward mounting and dismounting the engine additionally comprising a pulley attached to the rear part of the aircraft and to the attachment points at the front of the engine to allow the sliding of the engine on the detachable rails in a controlled manner.

6. The aircraft with a system for rearward mounting and dismounting an engine according to claim 5, wherein the pulley is an electrical pulley operated by a motor.

7. The aircraft with a system for rearward mounting and dismounting an engine according to claim 6, wherein the motor of the electrical pulley is placed outside the aircraft.

8. The aircraft with a system for rearward mounting and dismounting an engine according to claim 5, wherein the fuselage comprises a window for accessing the attachment points at the front of the engine when the engine is mounted.

9. A method for rearward dismounting an engine from an aircraft of claim 1, comprising the following steps:
removing a tailcone or a fairing from the rear part of the aircraft,
entering the longitudinal detachable rails into the rear part of the aircraft, and placing the longitudinal detachable rails on the internal supports and under the engine,
entering the slider into the rear part of the aircraft, placing the slider on the longitudinal detachable rails, and attaching the slider to the engine by means of the second removable attachment arrangement,
disengaging the engine from the rear part of the aircraft by detaching the first attachment arrangement,
rearward sliding of the slider and the engine on the longitudinal detachable rails,
transferring the engine onto an external fork-lift or trolley, and
disengaging the engine from the slider by detaching the second removable attachment arrangement.

10. A method for rearward dismounting an engine from an aircraft of claim 5, further comprising the following steps:
removing a tailcone or a fairing from the rear part of the aircraft,
entering the longitudinal detachable rails into the rear part of the aircraft, and placing the longitudinal detachable rails on the internal supports and under the engine,
entering the slider into the rear part of the aircraft, placing the slider on the longitudinal detachable rails, and attaching the slider to the engine by means of the second removable attachment arrangement,
disengaging the engine from the rear part of the aircraft by detaching the first attachment arrangement,
rearward sliding of the slider and the engine on the longitudinal detachable rails, controlled by the pulley,
transferring the engine onto an external fork-lift or trolley,
detaching the pulley from the attachment points at the front of the engine, and
disengaging the engine from the slider by detaching the second removable attachment arrangement.

11. An aircraft comprising a fuselage with a system for rearward mounting and dismounting an engine, the engine being placed inside a rear part of the aircraft when mounted, the system for rearward mounting and dismounting the engine comprising a first removable fastener configured to attach the engine to the fuselage in the rear part of the aircraft, wherein the system for rearward mounting and dismounting the engine additionally comprises:
internal supports fixed in the rear part of the aircraft,
at least two longitudinal detachable rails, to be placed on the internal supports and under the engine, and
slider to attach to the engine by means of a second removable fastener, to be placed on the longitudinal detachable rails.
